(19) United States
(12) Patent Application Publication
(10) Pub. No.: US 2025/0077596 A1
(43) Pub. Date: Mar. 6, 2025

(54) RECOMMENDATION BASED ON SEMANTIC UNDERSTANDING OF CONTENT ITEMS

(71) Applicant: Roblox Corporation, San Mateo, CA (US)

(72) Inventors: Xiaohong GONG, Sunnyvale, CA (US); Yexi JIANG, Menlo Park, CA (US); Yidi WANG, San Mateo, CA (US)

(73) Assignee: Roblox Corporation, San Mateo, CA (US)

(21) Appl. No.: 18/781,475

(22) Filed: Jul. 23, 2024

Related U.S. Application Data
(60) Provisional application No. 63/535,853, filed on Aug. 31, 2023.

(51) Int. Cl. G06F 16/9535; A63F 13/60; G06F 16/9538

(52) U.S. Cl. CPC G06F 16/9535; A63F 13/60; G06F 16/9538

(57) ABSTRACT

Implementations described herein relate to methods, systems, and computer-readable media to recommend content items. In some implementations, a method includes identifying candidate content items for recommendation to a user and assigning respective ranks to the candidate content items, wherein the respective ranks are personalized to the user. The method further includes selecting, based on the respective ranks, one or more candidate content items from the candidate content items. The method further includes providing the selected one or more candidate content items to a client device for display in a user interface.

### CROSS-REFERENCE TO RELATED APPLICATIONS

This application is a non-provisional application that claims priority under 35 U.S.C. § 119(e) to U.S. Provisional Patent Application No. 63/535,853, filed on Aug. 31, 2023, the contents of which are hereby incorporated by reference herein in its entirety.

### TECHNICAL FIELD

This disclosure relates generally to computer-based gaming, and more particularly but not exclusively, relates to methods, systems, and computer-readable media to recommend content items.

### BACKGROUND

Recommender systems are a tool to identify relevant items for a user. A recommender system can recommend products to customers, suggest similar products to those that a customer has already purchased, and/or recommend products that a customer might be interested in based on their activity. Some recommender systems utilize user-item interactions as input signals to identify items of interest to a user. Recommender systems can be used by businesses to increase sales and/or improve customer satisfaction. Recommender systems can also be used by individuals to make decisions, e.g., related to purchases.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

According to one aspect of the present disclosure, a computer-implemented method to recommend content items is provided. The method may include identifying candidate content items for recommendation to a user. The method may further include assigning respective ranks to the candidate content items, wherein the respective ranks are personalized to the user. The method may further include selecting, based on the respective ranks, one or more candidate content items from the candidate content items. The method may further include providing the selected one or more candidate content items to a client device for display in a user interface.

In some implementations, identifying the candidate content items may further include obtaining user feature embeddings based on user features; generating a user embedding based on the user feature embeddings using a first trained deep neural network (DNN); selecting content items that are associated with respective content item embeddings that are within a threshold distance of the user embedding.

In some implementations, the first trained deep neural network (DNN) may be from a first tower of a two tower model that includes a second trained DNN from a second tower. In some implementations, the first trained DNN and the second trained DNN may be trained to output user embeddings and content item embeddings that are close in vector space for user-content item pairs that have a groundtruth association and that are separated in vector space for user-content item pairs that do not have the groundtruth association.

In some implementations, identifying the candidate content items may include obtaining a prior content item embedding for a prior content item associated with the user; and selecting content items that are associated with respective content item embeddings that are within a threshold distance of the prior content item embedding.

In some implementations, identifying the candidate content items may include obtaining user feature embeddings based on user features; generating a user embedding based on the user feature embeddings using a first trained DNN; selecting a first set of content items that includes content items that are associated with respective content item embeddings that are within a threshold distance of the user embedding; obtaining a prior content item embedding for a prior content item associated with the user; selecting a second set of content items that includes content items that are associated with respective content item embeddings that are within a threshold distance of the prior content item embedding; and merging the first set of content items and the second set of content items.

In some implementations, the method may further include assigning the respective ranks may be based on one or more of user interests of the user, content item inventory associated with the candidate content items, play history of the user, purchase history of the user, or recommendation context.

In some implementations, the candidate content items may be virtual experiences that include one or more developer items. In some implementations, the content item embedding for each virtual experience may be a learned embedding based on respective developer item embeddings of the one or more developer items.

In some implementations, the candidate content items may be virtual experiences that include a plurality of assets that include one or more of audio assets, visual assets, or text assets. In some implementations, the content item embedding for each virtual experience may be an asset embedding based on the plurality of assets associated with the virtual experience.

In some implementations, the candidate content items may be virtual experiences that include a plurality of assets and one or more developer items. In some implementations, the content item embedding for each virtual experience may be a concatenation of an asset embedding based on the plurality of assets associated with the virtual experience and a learned embedding based on respective developer item embeddings of the one or more developer items.

In some implementations, the candidate content items may be one or more content items for purchase. In some implementations, the content item embedding for each content item for purchase may be a respective item feature embedding of the one or more content items.

According to another aspect of the present disclosure, a non-transitory computer-readable medium with instructions stored thereon is provided. The instructions stored thereon that, when executed by one or more hardware processors, cause the one or more hardware processors to perform operations. The operations may include identifying candidate content items for recommendation to a user. The operations may further include assigning respective ranks to the candidate content items, wherein the respective ranks are personalized to the user. The operations may further include selecting, based on the respective ranks, one or more candidate content items from the candidate content items. The operations may further include providing the selected one or more candidate content items to a client device for display in a user interface.

In some implementations, identifying the candidate content items may include obtaining user feature embeddings based on user features; generating a user embedding based on the user feature embeddings using a first trained DNN; and selecting content items that are associated with respective content item embeddings that are within a threshold distance of the user embedding.

In some implementations, the first trained DNN may be from a first tower of a two tower model that includes a second trained DNN from a second tower. In some implementations, the first trained DNN and the second trained DNN may be trained to output user embeddings and content item embeddings that are close in vector space for user-content item pairs that have a groundtruth association and that are separated in vector space for user-content item pairs that do not have the groundtruth association.

In some implementations, identifying the candidate content items may include obtaining a prior content item embedding for a prior content item associated with the user; and selecting content items that are associated with respective content item embeddings that are within a threshold distance of the prior content item embedding.

In some implementations, identifying the candidate content items may include obtaining user feature embeddings based on user features; generating a user embedding based on the user feature embeddings using a first trained DNN; selecting a first set of content items that includes content items that are associated with respective content item embeddings that are within a threshold distance of the user embedding; obtaining a prior content item embedding for a prior content item associated with the user; selecting a second set of content items that includes content items that are associated with respective content item embeddings that are within a threshold distance of the prior content item embedding; and merging the first set of content items and the second set of content items.

In some implementations, the operations may further include assigning the respective ranks may be based on one or more of user interests of the user, content item inventory associated with the candidate content items, play history of the user, purchase history of the user, or recommendation context.

In some implementations, the candidate content items may be virtual experiences that include one or more developer items. In some implementations, the content item embedding for each virtual experience may be a learned embedding based on respective developer item embeddings of the one or more developer items.

In some implementations, the candidate content items may be virtual experiences that include a plurality of assets that include one or more of audio assets, visual assets, or text assets. In some implementations, the content item embedding for each virtual experience may be an asset embedding based on the plurality of assets associated with the virtual experience.

In some implementations, the candidate content items may be virtual experiences that include a plurality of assets and one or more developer items. In some implementations, the content item embedding for each virtual experience may be a concatenation of an asset embedding based on the plurality of assets associated with the virtual experience and a learned embedding based on respective developer item embeddings of the one or more developer items.

In some implementations, the candidate content items may be one or more content items for purchase. In some implementations, the content item embedding for each content item for purchase may be a respective item feature embedding of the one or more content items.

According to yet another aspect of the present disclosure, a computing device is provided. The computing device may include one or more hardware processors. The computing device may include a non-transitory computer readable medium coupled to the one or more hardware processors, with instructions thereon, that when executed by the one or more hardware processors to perform operations. The operations may include identifying candidate content items for recommendation to a user. The operations may further include assigning respective ranks to the candidate content items, wherein the respective ranks are personalized to the user. The operations may further include selecting, based on the respective ranks, one or more candidate content items from the candidate content items. The operations may further include providing the selected one or more candidate content items to a client device for display in a user interface.

### BRIEF DESCRIPTION OF THE DRAWINGS

FIG. 1 is a diagram of an example system architecture, in accordance with some implementations.

FIG. 2 is a block diagram illustrating different components of a content-item recommender, in accordance with some implementations.

FIG. 3 is a diagram illustrating an example architecture of a user-content item two-tower model, in accordance with some implementations.

FIG. 4 is a diagram illustrating an example architecture of a content item-content item two tower model, in accordance with some implementations.

FIG. 5 is a flowchart illustrating an example method to recommend content items, in accordance with some implementations.

FIG. 6 is a block diagram illustrating an example computing device, in accordance with some implementations.

### DETAILED DESCRIPTION

Developer items are items that can be purchased in a virtual experience. For instance, a first-person shooter (FPS) virtual experience may include a number of developer items such as a handgun, a shield, a helmet, a vehicle, etc. Because each experience can have many developer items and a virtual-experience platform may have a large number (e.g., millions of virtual experiences) and users (e.g., tens or hundreds of millions of users), recommending developer items is a challenging problem.

Further, new developer items may be added to the virtual experience (or virtual-experience platform) that may have no prior user-association data (e.g., not used by any of the users). Therefore, it is difficult to identify users that may find the developer item-of-interest that can then receive the developer item as a recommendation. Recommending new developer items can suffer from a cold-start problem in the absence of such data.

Virtual-experience recommendation may also suffer from a cold-start problem. A new virtual experience may not have any play history or activity history of users associated with it, therefore making it difficult to recommend the virtual experience to particular users.

The methods, systems, and computer-readable media described herein address these and other technical problems with regard to recommendation of content items. In particular, by using learned multimodal (such as text, audio, image, video, etc.) semantic similarities between virtual experiences (as represented by content item embeddings), virtual experiences that are semantically similar to trending or popular virtual experiences or similar to virtual experiences a user has previously played can be identified and recommended. Similarly, new developer items can be recommended to users based on semantic similarity to prior content items. Thus, the described techniques generate and utilize content item embeddings that utilize semantic data about content items (virtual experiences, developer items, etc.) to incorporate multimodal understanding that can diversify the recommendations and to bootstrap new content items such as developer items or new virtual experiences.

A multi-stage recommender includes one or more candidate generators that retrieve the top K content items from a large corpus (e.g., that can include millions or billions of content items). One or more rerankers rank these top K product items per user based on the particular user's own interests, item inventory, play history, context, etc. to output the top N items. A personalization backend can take the top N items from the output of the rerankers and provide them to a client device for display to the user, e.g., as recommended content items.

The candidate generators are trained using a two-tower model to obtain a trained model (e.g., a deep neural network) that generates embeddings that reflect the association between user features and item features, or similarity between two items (e.g., co-played virtual experiences, co-purchased developer items, etc.) based on their semantic features.

By encoding semantic information into user embeddings and content item embeddings, the candidate generator can identify content items (e.g., virtual experiences, developer items, etc.) for recommendation that do not have sufficient engagement data, thus addressing the cold-start problem where such items may otherwise not be recommended to users.

Incorporating semantic features enables the described candidate generation techniques to overcome popularity bias (that results in popular items being recommended at a greater rate than other items). To generate user embeddings, semantic information such as past played virtual experiences, past purchased developer items, etc. is utilized. This can include the item structured metadata, text, audio, and/or visual information, such as image or video. To generate item embeddings, semantic information, such as item structured metadata, text, audio, and/or visual information, etc. is utilized. Multimodal transformers or cross-modal transformers can be utilized to unify the encoding of the text, audio, image, and/or video information.

Since a virtual experience can include many developer items, the embedding for the virtual experience can be obtained as a learned embedding from a combination of developer item embeddings (of developer items that are associated with the virtual experience). Further, the virtual experience embedding may be obtained by concatenating an embedding of audio, visual, and/or text information of the virtual experience and the combined embeddings of the developer items associated with the experience.

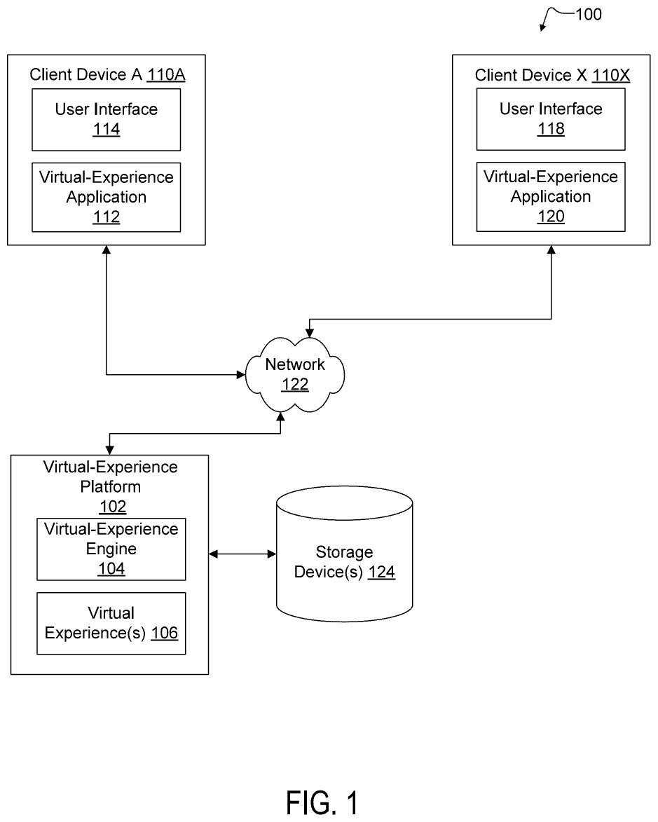

FIG. 1 is a diagram of an example system architecture 100 that includes a 3D environment platform that can support construction and presentation of 3D objects, in accordance with some implementations. In the example of FIG. 1, the 3D environment platform will be described in the context of a virtual-experience platform 102 purely for purposes of explanation, and various other implementations can provide other types of 3D environment platforms, such as online meeting platforms, virtual reality (VR) or augmented reality (AR) platforms, or other types of platforms that can provide 3D content. The description provided herein for the virtual-experience platform 102 and other elements of the system architecture 100 can be adapted to be operable with such other types of 3D environment platforms.

Virtual-experience platforms (also referred to as “user-generated content platforms” or “user-generated content systems”) offer a variety of ways for users to interact with one another, such as while the users are playing an electronic virtual experience. For example, users of a virtual-experience platform may work together towards a common goal, share various virtual gaming items, send electronic messages to one another, and so forth. Users of a virtual-experience platform may play virtual experiences using characters, such as the 3D avatars, which the users can navigate through a 3D world rendered in the electronic virtual experience.

A virtual-experience platform may also enable users of the platform to create and animate avatars, as well as enabling the users to create other graphical objects to place in the 3D world. For example, users of the virtual-experience platform may be allowed to create, design, and customize the avatar, and to create other 3D objects for presentation in the 3D world.

In FIG. 1, the example system architecture 100 (also referred to as “system” herein) includes the virtual-experience platform 102, a first client device 110a and at least one second client device X 110X (generally referred to as “client device(s) 110” herein). The virtual-experience platform 102 can include, among other things, a virtual-experience engine 104 and one or more electronic virtual experiences 106. The system architecture 100 is provided for illustration of one possible implementation. In other implementations, the system architecture 100 may include the same, fewer, more, or different elements configured in the same or different manner as that shown in FIG. 1.

A communication network 122 may be used for communication between the virtual-experience platform 102 and the client devices 110, and/or between other elements in the system architecture 100. The network 122 may include a public network (e.g., the Internet), a private network (e.g., a local area network (LAN) or wide area network (WAN)), a wired network (e.g., Ethernet network), a wireless network (e.g., an 802.11 network, a Wi-Fi network, or wireless LAN (WLAN)), a cellular network (e.g., a long term evolution (LTE) network), routers, hubs, switches, server computers, or a combination thereof.

The client device 110A can include a virtual-experience application 112 and one or more user interfaces 114 (e.g., audio/video input/output devices). Similarly, the client device X 100X can include a virtual-experience application 120 and user interfaces 118 (e.g., audio/video input/output devices). The audio/video input/output devices can include one or more of a microphone, speakers, headphones, display device, camera, etc.

The system architecture 100 may further include one or more storage devices 124. The storage device 124 may be, for example, a storage device located within the virtual-experience platform 102 or communicatively coupled to the virtual-experience platform 102 via the network 122 (such as depicted in FIG. 1). The storage device 124 may store, for example, graphical objects that are rendered in the virtual experience 106 by the virtual-experience engine 104 or by the virtual-experience applications 112/120, as well as the configuration/properties information of the graphical objects.

In some embodiments, the storage devices 124 can be part of one or more separate content delivery networks that provide the graphical objects rendered in the virtual experience 106. For instance, an avatar creator can publish avatar templates in a library accessible at a first storage device, and other 3D object creators can (separately and independently from the avatar creator) publish 3D objects in a library accessible at a second storage device. Then, the virtual-experience application 112 may pull (or have pushed to it) graphical objects (avatars and other 3D objects) stored in the first/second storage devices, for computation/compilation at runtime for presentation during the course of playing the virtual experience.

In one implementation, the storage device 124 may be a non-transitory computer readable memory (e.g., random access memory), a cache, a drive (e.g., a hard drive), a flash drive, a database system, or another type of component or device capable of storing data and other content. The storage device 124 may also include multiple storage components (e.g., multiple drives or multiple databases) that may also span multiple computing devices (e.g., multiple server computers).

In some implementations, the virtual-experience platform 102 can include a server having one or more computing devices (e.g., a cloud computing system, a rackmount server, a server computer, cluster of physical servers, etc.). In some implementations, a server may be included in the virtual-experience platform 102, be an independent system, or be part of another system or platform.

In some implementations, the virtual-experience platform 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the virtual-experience platform 102 and to provide a user with access to virtual-experience platform 102. The virtual-experience platform 102 may also include a website (e.g., a web page) or application backend software that may be used to provide a user with access to content provided by virtual-experience platform 102. For example, a user may access virtual-experience platform 102 using the virtual-experience application 112 on the client device 110.

In some implementations, virtual-experience platform 102 may be a type of social network providing connections between users or a type of user-generated content system that allows users (e.g., end-users or consumers) to communicate with other users on the virtual-experience platform 102, where the communication may include voice chat (e.g., synchronous and/or asynchronous voice communication), video chat (e.g., synchronous and/or asynchronous video communication), or text chat (e.g., synchronous and/or asynchronous text-based communication). In some implementations of the disclosure, a “user” may be represented as a single individual. However, other implementations of the disclosure encompass a “user” (e.g., creating user) being an entity controlled by a set of users or an automated source. For example, a set of individual users federated as a community or group in a user-generated content system may be considered a “user.”

In some implementations, virtual-experience platform 102 may be a virtual gaming platform. For example, the gaming platform may provide single-player or multiplayer virtual experiences to a community of users that may access or interact with virtual experiences using client devices 110 via the network 122. In some implementations, virtual experiences (also referred to as “video virtual experience,” “online virtual experience,” or “virtual virtual experience” etc. herein) may be two-dimensional (2D) virtual experiences, three-dimensional (3D) virtual experiences (e.g., 3D user-generated virtual experiences), virtual reality (VR) virtual experiences, or augmented reality (AR) virtual experiences, for example. In some implementations, users may participate in virtual experiences with other users. In some implementations, a virtual experience may be played in real-time with other users of the virtual experience.

In some implementations, virtual experiences may refer to interaction of one or more players using client devices (e.g., the client device 110) within a virtual experience (e.g., the virtual experience 106) or the presentation of the interaction on a display or other user interfaces (e.g., the user interface 114/118) of a client device 110.

In some implementations, the virtual experience 106 can include an electronic file that can be executed or loaded using software, firmware or hardware configured to present the virtual experience content (e.g., digital media item) to an entity. In some implementations, the virtual-experience application 112 may be executed and the virtual experience 106 rendered in connection with the virtual-experience engine 104. In some implementations, the virtual experience 106 may have a common set of rules or common goal, and the environments of a virtual experience 106 share a common set of rules or common goal. In some implementations, different virtual experiences may have different rules or goals from one another.

In some implementations, virtual experiences may have one or more environments (also referred to as “gaming environments” or “virtual environments” herein) where multiple environments may be linked. An example of an environment may be a 3D environment. The one or more environments of the virtual experience 106 may be collectively referred to a “world” or “gaming world” or “virtual world” or “universe” herein. For example, a user may build a virtual environment that is linked to another virtual environment created by another user. A character of the virtual experience (such as a 3D avatar) may cross the virtual border to enter the adjacent virtual environment.

It may be noted that 3D environments or 3D worlds use graphics that provide a three-dimensional representation of geometric data representative of virtual experience content (or at least present virtual experience content to appear as 3D content whether or not 3D representation of geometric data is used). 2D environments or 2D worlds use graphics that provide two-dimensional representation of geometric data representative of virtual experience content.

In some implementations, the virtual-experience platform 102 can host one or more virtual experiences 106 and can permit users to interact with the virtual experiences 106 using the virtual-experience application 112 of the client device 110. Users of the virtual-experience platform 102 may play, create, interact with, or build virtual experiences 106, communicate with other users, and/or create and build objects (e.g., also referred to as “item(s)” or “virtual-experience objects” or “virtual virtual experience item(s)” or “graphical objects” herein) of virtual experiences 106. For example, in generating user-generated virtual items, users may create characters, animation for the characters, decoration for the characters, one or more virtual environments for an interactive virtual experience, or build structures used in the virtual experience 106, among others. In some implementations, users may buy, sell, or trade virtual-experience objects, such as in-platform currency (e.g., virtual currency), with other users of the virtual-experience platform 102.

In some implementations, virtual-experience platform 102 may transmit virtual experience content to virtual-experience applications (e.g., the virtual-experience application 112). In some implementations, virtual experience content (also referred to as “content” herein) may refer to any data or software instructions (e.g., virtual-experience objects, virtual experience, user information, video, images, commands, media item, etc.) associated with virtual-experience platform 102 or virtual-experience applications. In some implementations, virtual-experience objects (e.g., also referred to as “item(s)” or “objects” or “virtual experience item(s)” herein) may refer to objects that are used, created, shared, or otherwise depicted in the virtual experience 106 of the virtual-experience platform 102 or virtual-experience applications 112 or 120 of the client devices 110. For example, virtual-experience objects may include a part, model, character or components thereof (like faces, arms, lips, etc.), tools, weapons, clothing, buildings, vehicles, currency, flora, fauna, components of the aforementioned (e.g., windows of a building), and so forth.

It may be noted that the virtual-experience platform 102 hosting virtual experiences 106 is provided for purposes of illustration. In some implementations, virtual-experience platform 102 may host one or more media items that can include communication messages from one user to one or more other users. Media items can include, but are not limited to, digital video, digital movies, digital photos, digital music, audio content, melodies, website content, social media updates, electronic books, electronic magazines, digital newspapers, digital audio books, electronic journals, web blogs, real-simple syndication (RSS) feeds, electronic comic books, software applications, etc. In some implementations, a media item may be an electronic file that can be executed or loaded using software, firmware or hardware configured to present the digital media item to an entity.

In some implementations, the virtual experience 106 may be associated with a particular user or a particular group of users (e.g., a private virtual experience), or made widely available to users of the virtual-experience platform 102 (e.g., a public virtual experience). In some implementations, where virtual-experience platform 102 associates one or more virtual experiences 106 with a specific user or group of users, virtual-experience platform 102 may associate the specific user(s) with a virtual experience 106 using user account information (e.g., a user account identifier such as username and password).

In some implementations, virtual-experience platform 102 or client devices 110 may include the virtual-experience engine 104 or virtual-experience application 112/120. In some implementations, virtual-experience engine 104 may be used for the development or execution of virtual experiences 106. For example, virtual-experience engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual-experience engine 104 may generate commands that help compute and render the virtual experience (e.g., rendering commands, collision commands, animation commands, physics commands, etc.). In some implementations, virtual-experience applications 112/118 of client devices 110 may work independently, in collaboration with virtual-experience engine 104 of virtual-experience platform 102, or a combination of both, in order to perform the operations described herein related to creating and presenting 3D objects.

In some implementations, both the virtual-experience platform 102 and client devices 110 execute a virtual-experience engine or a virtual-experience application (104, 112, 120, respectively). The virtual-experience platform 102 using virtual-experience engine 104 may perform some or all the virtual-experience engine functions (e.g., generate physics commands, animation commands, rendering commands, etc.), or offload some or all the virtual-experience engine functions to the virtual-experience application 112 of client device 110. In some implementations, each virtual experience 106 may have a different ratio between the virtual-experience engine functions that are performed on the virtual-experience platform 102 and the virtual-experience engine functions that are performed on the client devices 110.

For example, the virtual-experience engine 104 of the virtual-experience platform 102 may be used to generate physics commands in cases where there is a collision between at least two virtual-experience objects, while the additional virtual-experience engine functionality (e.g., generate rendering commands) may be offloaded to the client device 110. In some implementations, the ratio of virtual-experience engine functions performed on the virtual-experience platform 102 and client device 110 may be changed (e.g., dynamically) based on virtual-experience conditions. For example, if the number of users participating in a particular virtual experience 106 exceeds a threshold number, the virtual-experience platform 102 may perform one or more virtual-experience engine functions that were previously performed by the client devices 110.

For example, users may be playing a virtual experience 106 on client devices 110, and may send control instructions (e.g., user inputs, such as right, left, up, down, user election, or character position and velocity information, etc.) to the virtual-experience platform 102. After receiving control instructions from the client devices 110, the virtual-experience platform 102 may send virtual-experience instructions (e.g., position and velocity information of the characters participating in the virtual experience or commands, such as rendering commands, collision commands, etc.) to the client devices 110 based on control instructions. For instance, the virtual-experience platform 102 may perform one or more logical operations (e.g., using virtual-experience engine 104) on the control instructions to generate virtual-experience instructions for the client devices 110. In other instances, virtual-experience platform 102 may pass one or more or the control instructions from one client device 110 to other client devices participating in the virtual experience 106. The client devices 110 may use the virtual-experience instructions and render the virtual experience for presentation on the displays of client devices 110.

In some implementations, the control instructions may refer to instructions that are indicative of in-virtual experience actions of a user's character. For example, control instructions may include user input to control the in-virtual experience action, such as right, left, up, down, user selection, gyroscope position and orientation data, force sensor data, etc. The control instructions may include character position and velocity information. In some implementations, the control instructions are sent directly to the virtual-experience platform 102. In other implementations, the control instructions may be sent from the client device 110 to another client device, where the other client device generates instructions using the local virtual-experience application 120. The control instructions may include instructions to play a voice communication message or other sounds from another user on an audio device (e.g., speakers, headphones, etc.), for example voice communications or other sounds generated using the audio spatialization techniques as described herein.

In some implementations, virtual-experience instructions may refer to instructions that allow the client device 110 to render a virtual experience, such as a multiplayer virtual experience. The virtual-experience instructions may include one or more of user input (e.g., control instructions), character position and velocity information, or commands (e.g., physics commands, animation commands, rendering commands, collision commands, etc.).

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may also be referred to as a “user device.” In some implementations, one or more client devices 110 may connect to the virtual-experience platform 102 at any given moment. It may be noted that the number of client devices 110 is provided as illustration, rather than limitation. In some implementations, any number of client devices 110 may be used.

In some implementations, each client device 110 may include an instance of the virtual-experience application 112 or 120. In one implementation, the virtual-experience application 112 or 120 may permit users to use and interact with virtual-experience platform 102, such as control a virtual character in a virtual experience hosted by virtual-experience platform 102, or view or upload content, such as virtual experiences 106, images, video items, web pages, documents, and so forth. In one example, the virtual-experience application may be a web application (e.g., an application that operates in conjunction with a web browser) that can access, retrieve, present, or navigate content (e.g., virtual character in a virtual environment, etc.) served by a web server. In another example, the virtual-experience application may be a native application (e.g., a mobile application, app, or a gaming program) that is installed and executes local to client device 110 and allows users to interact with virtual-experience platform 102. The virtual-experience application may render, display, or present the content (e.g., a web page, a media viewer) to a user. In an implementation, the virtual-experience application may also include an embedded media player) that is embedded in a web page.

According to aspects of the disclosure, the virtual-experience application 112/120 may be a virtual-experience application for users to build, create, edit, upload content to the virtual-experience platform 102 as well as interact with virtual-experience platform 102 (e.g., play virtual experiences 106 hosted by virtual-experience platform 102). As such, the virtual-experience application 112/120 may be provided to the client device 110 by the virtual-experience platform 102. In another example, the virtual-experience application may be an application that is downloaded from a server.

In some implementations, a user may login to virtual-experience platform 102 via the virtual-experience application. The user may access a user account by providing user account information (e.g., username and password) where the user account is associated with one or more characters available to participate in one or more virtual experiences 106 of virtual-experience platform 102.

In general, functions described in one implementation as being performed by the virtual-experience platform 102 can also be performed by the client device(s) 110, or a server, in other implementations if appropriate. In addition, the functionality attributed to a particular component can be performed by different or multiple components operating together. The virtual-experience platform 102 can also be accessed as a service provided to other systems or devices through appropriate application programming interfaces (APIs), and thus is not limited to use in websites.

### Content-Item Recommender

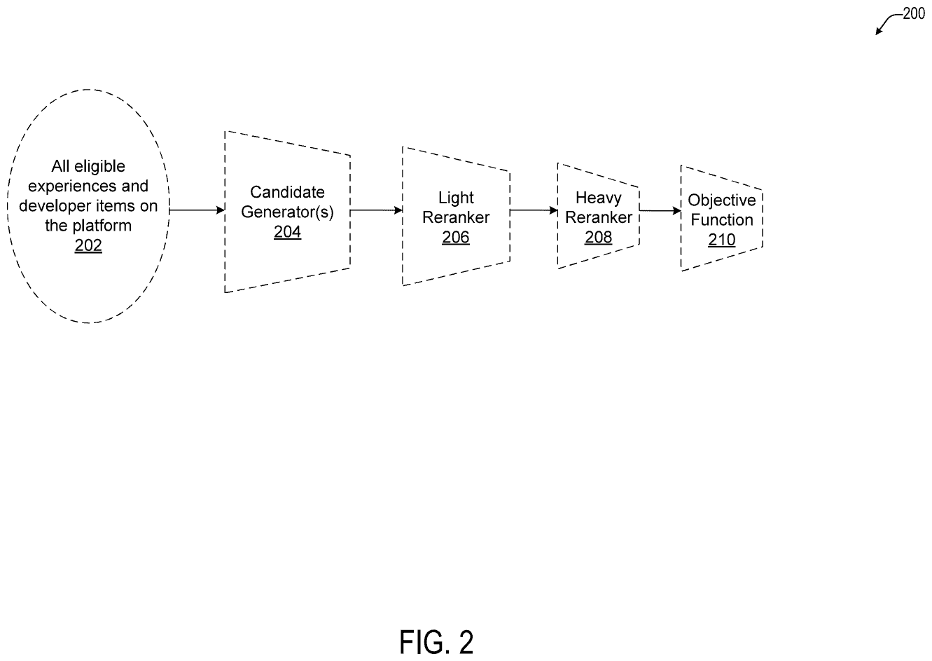

FIG. 2 is a block diagram illustrating different components of a content-item recommender, in accordance with some implementations. Content items may include virtual experiences and/or developer items. Eligible virtual experiences and/or developer items 202 on the virtual-experience platform are identified. For example, certain virtual experiences may be deemed ineligible for a particular user, e.g., based on user age (e.g., a 15 year old user is ineligible for experiences that are for 17+ users); location (e.g., a user in India may be ineligible for experiences that are marked US-only); user device capabilities (e.g., processing, network, battery, etc.); etc. Further, certain virtual experiences may be deemed ineligible for other reasons, e.g., restrictions specified by the developer of the virtual experience, restrictions due to server capacity, network capacity, etc.

One or more candidate generators 204 identify candidate content items for recommendation. One or more of heavy reranker(s) 208 (e.g., that are computationally expensive) and a light reranker 206 may be utilized to assign ranks to the identified candidate content items. An objective function 210 may be optionally utilized to further filter the ranked content items and select one or more content items that are sent to a client device to display to the user. In different implementations, the content-item recommender may be implemented as part of a virtual-experience application 112/120 and/or part of virtual-experience engine 104. While the description herein refers to recommendations of content items in the context of a virtual-experience platform (virtual environment) that includes virtual experiences, developer items, and content items for purchase the techniques described herein are usable in any recommendation context, e.g., where the content items have semantic information (in one or modalities such as text, image, video, etc.), where the recommender needs to overcome a cold-start problem, etc.

### Training of Deep Neural Network (DNN): User-Content Item Two Tower Model

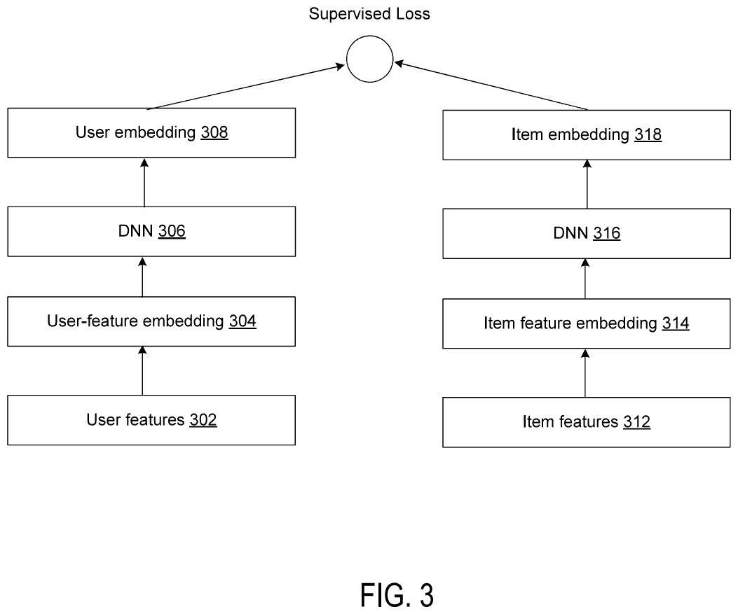

FIG. 3 is a diagram illustrating an example architecture of a user-content item two tower model, in accordance with some implementations. The two tower model includes a left tower (blocks 302-308) that generates user embeddings and a right tower (blocks 312-318) that generates item embeddings. The left tower may be utilized to calculate the user embedding for the particular user.

In some implementations, the user-content item two tower model may be utilized to train deep neural network (DNN) 306 and DNN 316 to generate respective user embeddings and content item embeddings. The training data may include a plurality of pairs of users and content items (e.g., user, content item) that have a groundtruth association. For example, if the content item is a developer item that the user purchased, there is a groundtruth association between the user and the developer item. In another example, if the content item is a virtual experience that the user participated in (played), there is a groundtruth association between the user and the virtual experience, where groundtruth association is based on the user history and indicates that the particular content item is of interest to the user. In various implementations, the plurality of pairs may be obtained automatically (based on prior user activity on the virtual-experience platform) and/or may be specific by the users (e.g., a user may provide a rating for a virtual experience or developer item, indicating their level of interest in that content item). The plurality of pairs in the training data may also include other pairs of users and content items, where there is no groundtruth association (e.g., unknown relationship) and/or negative association (user expresses disinterest in the content item).

During training, in the left tower, user feature embeddings 304 may be calculated from user features 302 for each user in the plurality of pairs. The calculated user feature embeddings 304 are provided to a first DNN 306 that generates a user embedding 308 based on the user feature embeddings 304.

Further, during training, in the right tower, item feature embeddings 314 may be calculated from item features 312 for each content item in the plurality of pairs. The item features may include one or more of item metadata (e.g., title, developer name, rating on the platform, item type, etc.) as well as text, audio, and visual information, such as image or video, associated with the item. The item feature embedding may be generated by encoding the item features using a multimodal transformer and/or a cross-modal transformer that unifies the encoding across the various types of data in the item features. The calculated item feature embeddings 314 are provided to a second DNN 316 that generates an item embedding 318 based on the item feature embeddings 314.

Further, during training, a supervised loss may be calculated as a vector distance between the user embedding 308 and the item embedding 318 for each pair. The loss function is selected such that for pairs where there is the groundtruth association, the loss is minimized. In other words, the vector distance between the user embedding 308 and the item embedding 318 is low for such pairs, whereas the vector distance in the absence of the groundtruth association is high. The loss value is utilized to adjust one or more parameters of DNN 306 and/or DNN 316. After the adjusting, the respective embeddings generated by DNN 306 and DNN 316 are closer in vector space for pairs with the groundtruth association. The training may be performed with a stopping criterion, e.g., compute budget exhausted, training data exhausted, threshold number of training epochs being completed, improvement between consecutive training iterations falling below a threshold, etc. Upon completion of the training, the left tower and the right tower can be utilized separately to generate user embeddings and item embeddings for incoming data in an inference phase.

### Training of DNN: Content Item-Content Item Two Tower Model

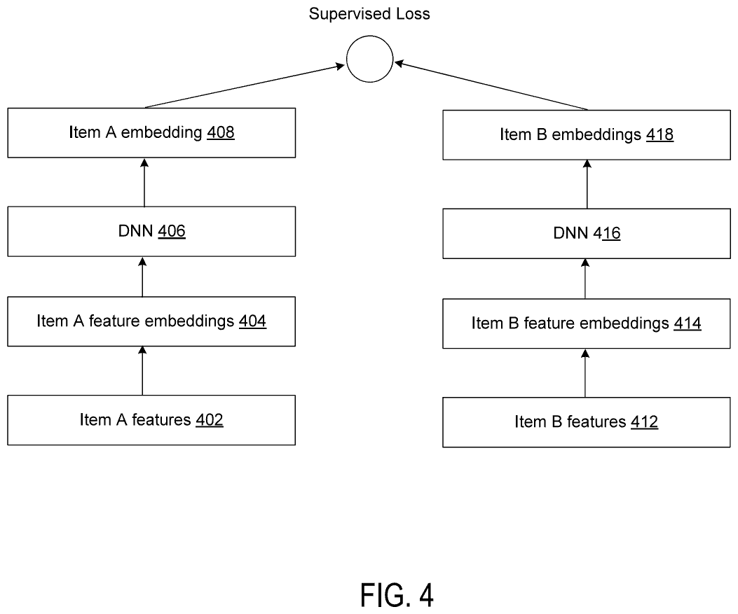

FIG. 4 is a diagram illustrating an example architecture of a content item-content item two tower model, in accordance with some implementations. The two tower model includes a left tower (402-408) and a right tower (412-418). Respective feature embeddings 404 and 414 are generated based on item features 402 corresponding to item A and item features 412 corresponding to item B. The feature embeddings are provided to DNN 406 and DNN 416 that generate respective item feature embeddings 408 and 418. In some implementations, DNN 406 and DNN 416 may be the same DNN.

Further, during training, a supervised loss may be calculated as a vector distance between the item A embedding 408 and the item B embedding 418 for each pair of items A and B. The loss function is selected such that for pairs where there is a relationship between the items, the loss is minimized. For example, if content items A and B are co-played virtual experiences (the same user participated in both), there is a known relationship between the content items. In another example, co-purchased developer items or other co-purchased content items (e.g., the same user purchased both) also have a relationship. Any other prior relationship may be used in addition or alternatively. In other words, the vector distance between the item A embedding 408 and the item B embedding 418 is low for such pairs, whereas the vector distance in the absence of a relationship between the two content items is high. The loss value is utilized to adjust one or more parameters of DNN 406 and/or DNN 416. After the adjusting, the respective embeddings generated by DNN 406 and DNN 416 are closer in vector space for content item pairs that have a relationship. The training may be performed with a stopping criterion, e.g., compute budget exhausted, the training data (pairs of items) exhausted, a threshold number of training epochs being completed, improvement between consecutive training iterations falling below a threshold, etc. Upon completion of the training, DNN 406/416 can be utilized separately to generate item embeddings for incoming data in an inference phase.

### Identifying Candidate Content Items (Inference)

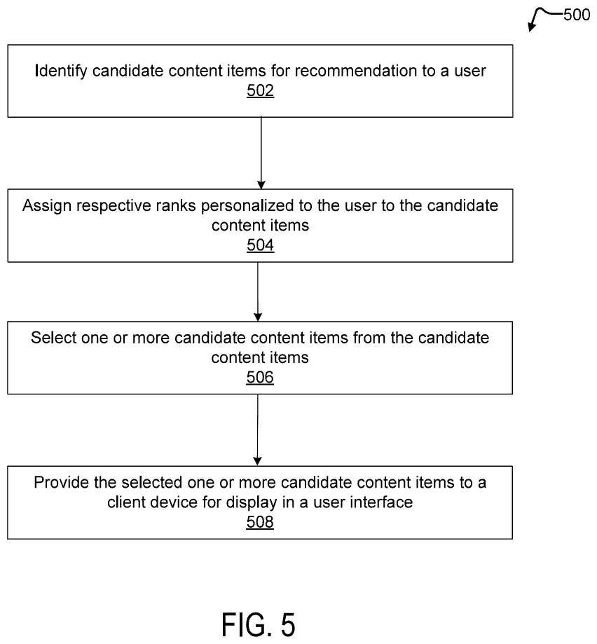

FIG. 5 is a flowchart illustrating an example method 500 to recommend content items, in accordance with some implementations. The method of FIG. 5 is implemented with specific user permission to access user data such as purchase history (e.g., of developer items such as avatar accessories, or other developer items), past play history (participation in one or more virtual experiences), context features such as the user-device type (e.g., desktop/laptop, smartphone, tablet, game console, or other computing device), user location (e.g., country), user language, or other features. In some implementations, the method of FIG. 5 may be used to implement one or more candidate generators 204. In different implementations, method 500 may be implemented as part of a virtual-experience application 112/120 and/or part of virtual-experience engine 104.

Method 500 may begin at block 502. At block 502, one or more candidate content items are identified for recommendation to a user. In some implementations, to identify the candidate content items, one or more of a user embedding for the particular user and/or a content item embedding may be calculated using a trained model, e.g., one or more deep neural networks (DNNs) trained using a two tower model. For example, one DNN may be trained to calculate user embeddings, while another DNN may be trained to calculate item embeddings. In some implementations, the same DNN may calculate both user embeddings as well as content item embeddings.

For instance, to identify the candidate content items, one or more of a user embedding for the particular user and/or a content item embedding may be calculated using a trained model, e.g., one or more deep neural networks (e.g., any of DNNs 306, 316, 406, 416) trained using a two tower model. For example, a first DNN (e.g., 306) may be trained to calculate user embeddings, while a second DNN (e.g., 316, 406, 416) may be trained to calculate item embeddings. In some implementations, the same DNN may calculate both user embeddings as well as content item embeddings.

In some implementations, to identify content items to recommend for a particular user, user feature embeddings for the particular user are generated based on user features. A user embedding is generated for the user based on the user feature embeddings using the first trained DNN (e.g., DNN 306). Content items that are associated with respective content item embeddings that are within a threshold distance of the user embedding are then selected. For example, in some implementations, content embeddings may be precomputed using a second trained DNN (316, 406, 416) and stored. Further, in some implementations, user embedding may also be precomputed. As the content information is less ephemeral, e.g., since virtual experience, developer items, and/or content items for purchase may not change over time (or may change slowly), content item embeddings can be calculated offline, e.g., with a recurring pipeline that is executed at certain intervals (e.g., every 6 hours, 1 day, 1 week, upon changes to a threshold number or proportion of content items, etc.). Similarly, user embeddings may be precomputed and stored.

In some implementations, the first trained DNN (e.g., 306) may be from a first tower (302-308) of a two tower model that includes a second trained DNN (e.g., 316) from a second tower (312-318). In these implementations, the first trained DNN and the second trained DNN are trained to output user embeddings and content item embeddings that are close in vector space for user-content item pairs that have a groundtruth association and that are separated in vector space for user-content item pairs that do not have the groundtruth association.

In some implementations, identifying the one or more content items may include obtaining a prior content item embedding for a prior content item associated with the user and selecting content items that are associated with respective content item embeddings that are within a threshold distance of the prior item embedding. For example, the prior content item may be a virtual experience that the user participated in, a developer item that the user purchased, tried out, or otherwise used, a content item for purchase that the user purchases, tired out, or otherwise used, etc. In some implementations, the content items may be precomputed and only the comparison may be performed at the time of serving the recommendation.

In some implementations, the user-content item embedding comparison may be used to select a first set of content items and the content item-content item embedding comparison may be used to select a second set of content items. The identified content items may be from a merged set that include items from both the first set and the second set. Block 502 may be followed by block 504.

At block 504, respective ranks are assigned to the candidate content items. The respective ranks may be personalized to the user, e.g., are based on user-specific features or attributes, obtained with user permission. In some implementations, assigning the respective ranks may be based on one or more of user interests of the user, content item inventory associated with the candidate content items, play history of the user, content-item purchase history of the user, or recommendation context. In various implementations, different combinations of these factors may be used to assign the respective ranks, or a particular factor may be used to assign the respective ranks. Block 504 may be followed by block 506.

At block 506, one or more candidate content items are selected from the candidate content items based on the respective ranks. Block 506 may be followed by block 508.

At block 508, the selected one or more candidate content items are provided to a client device for display in a user interface.

In some implementations, the candidate content items may be virtual experiences that include one or more developer items. In these implementations, the content item embedding for each virtual experience may be a learned embedding based on respective developer item embeddings of the one or more developer items.

In some implementations, the candidate content items may be virtual experiences that include a plurality of assets that include one or more of audio assets, visual assets, or text assets. In these implementations, the content item embedding for each virtual experience may be an asset embedding based on the plurality of assets associated with the virtual experience.

In some implementations, the candidate content items may be virtual experiences that include a plurality of assets and one or more developer items. In some of these implementations, the candidate content item embedding for each virtual experience may be a concatenation of an asset embedding based on the plurality of assets associated with the virtual experience and a learned embedding based on respective developer item embeddings of the one or more developer items.

In some implementations, the candidate content items are one or more content items for purchase. In some of these implementations, the content item embedding for each content item for purchase is a respective item feature embedding of the one or more content items.

In some implementations, user features for the user may be obtained, with user permission. For example, user features may include one or more of purchase history (e.g., of avatar accessories, developer items that can be purchased on the virtual-experience platform, etc.), past play history (participation in one or more virtual experiences), context features such as the user device type (e.g., desktop/laptop, smartphone, tablet, game console, or other computing device), user location (e.g., country), user language, or other features. A feature embedding for the user may be generated based on these features, including semantic information about the past played virtual experiences and/or the past purchased developer items. In some implementations, the user embedding may be a multidimensional vector that is calculated using any suitable technique. Since the user embeddings and/or item embeddings are obtained leveraging the content-specific information, these can be reused in other use cases (besides recommendation).

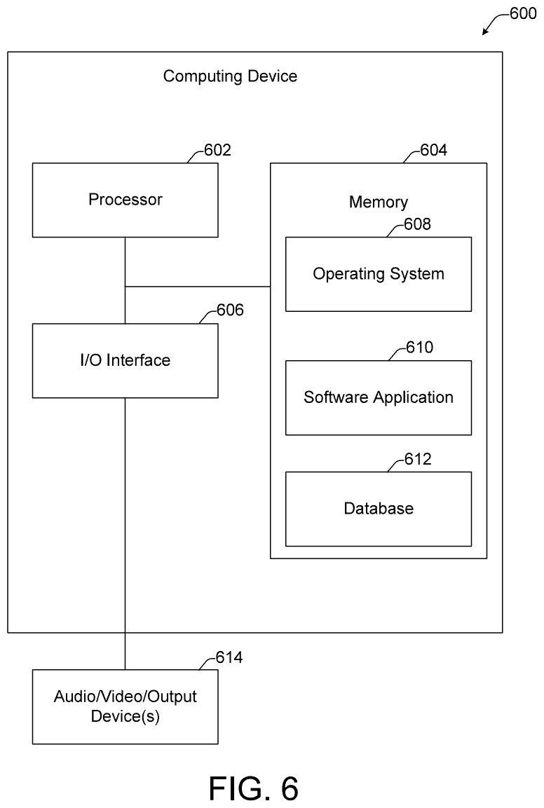

FIG. 6 is a block diagram of an example computing device 600 which may be used to implement one or more features described herein. The client devices 110 and/or the virtual-experience platform 102 of FIG. 1 may be provided in the form of the computing device 600 of FIG. 6. In one example, the computing device 600 may be used to perform the methods described herein. The computing device 600 can be any suitable computer system, server, or other electronic or hardware device. For example, the computing device 600 can be a mainframe computer, desktop computer, workstation, portable computer, or electronic device (portable device, mobile device, cell phone, smartphone, tablet computer, television, TV set top box, personal digital assistant (PDA), media player, virtual experience device, wearable device, etc.). In some implementations, the computing device 600 includes a processor 602, a memory 604, an input/output (I/O) interface 606, and audio/video input/output devices 614.

The processor 602 can be one or more processors and/or processing circuits to execute program code and control basic operations of the computing device 600. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

The memory 604 may be provided in the computing device 600 for access by the processor 602, and may be any suitable processor-readable storage medium, e.g., random access memory (RAM), read-only memory (ROM), electrical erasable read-only memory (EEPROM), flash memory, etc., suitable for storing instructions for execution by the processor, and located separate from processor 602 and/or integrated therewith. The memory 604 can store software executable on the computing device 600 by the processor 602, including an operating system 608, one or more applications 610 (e.g., a virtual-experience application) and its related data 612. The application 610 is an example of a tool that can be used to embody the virtual-experience applications 112/120 or the virtual-experience engine 104. In some implementations, the application 610 can include instructions that, in response to execution by the processor 602, enable the processor 602 to perform or control performance of the operations described herein with respect to creating and/or presenting 3D objects.

Any software in the memory 604 can alternatively be stored on any other suitable storage location or computer-readable medium. In addition, memory 604 (and/or other connected storage device(s)) can store instructions and data used in the features described herein. Memory 604 and any other type of storage (magnetic disk, optical disk, magnetic tape, or other tangible media) can be considered “storage” or “storage devices.”

The I/O interface 606 can provide functions to enable interfacing the computing device 600 with other systems and devices. For example, network communication devices, storage devices, and input/output devices can communicate with the computing device 600 via an I/O interface 606. In some implementations, the I/O interface 606 can connect to interface devices including input devices (keyboard, pointing device, touchscreen, microphone, camera, scanner, etc.) and/or output devices (display device, speaker devices, printer, motor, etc.), which are collectively shown as at least one audio/video input/output device 614.

The audio/video input/output devices 614 can include an audio input device (e.g., a microphone, etc.) that can be used to receive audio messages as input, an audio output device (e.g., speakers, headphones, etc.) and/or a display device, that can be used to provide graphical and visual output such as rendered 3D avatars or other 3D objects.

For case of illustration, FIG. 6 shows one block for each of processor 602, memory 604, I/O interface 606, the application 610, etc. These blocks may represent one or more processors or processing circuitries, operating systems, memories, I/O interfaces, applications, and/or software modules. In other implementations, the computing device 600 may not have all of the components shown and/or may have other elements including other types of elements instead of, or in addition to, those shown herein.

A user device can also implement and/or be used with features described herein. Example user devices can be computer devices including some similar components as the computing device 600, e.g., processor(s) 602, memory 604, and I/O interface 606. An operating system, software and applications suitable for the client device can be provided in memory and used by the processor. The I/O interface for a client device can be connected to network communication devices, as well as to input and output devices, e.g., a microphone for capturing sound, a camera for capturing images or video, audio speaker devices for outputting sound, a display device for outputting images or video, or other output devices. A display device within the audio/video input/output devices 614, for example, can be connected to (or included in) the computing device 600 to display images pre- and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

One or more methods described herein (e.g., the method 300) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., field-programmable gate array (FPGA), complex programmable logic device), general purpose processors, graphics processors, application specific integrated circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method to recommend content items, the method comprising:
identifying candidate content items for recommendation to a user;
assigning respective ranks to the candidate content items, wherein the respective ranks are personalized to the user;
selecting, based on the respective ranks, one or more candidate content items from the candidate content items; and
providing the selected one or more candidate content items to a client device for display in a user interface.

2. The computer-implemented method of claim 1, wherein identifying the candidate content items includes:
obtaining user feature embeddings based on user features;
generating a user embedding based on the user feature embeddings using a first trained deep neural network (DNN); and
selecting content items that are associated with respective content item embeddings that are within a threshold distance of the user embedding.

3. The computer-implemented method of claim 2, wherein the first trained DNN is from a first tower of a two tower model that includes a second trained DNN from a second tower, and wherein the first trained DNN and the second trained DNN are trained to output user embeddings and content item embeddings that are close in vector space for user-content item pairs that have a groundtruth association and that are separated in vector space for user-content item pairs that do not have the groundtruth association.

4. The computer-implemented method of claim 1, wherein identifying the candidate content items includes:
obtaining a prior content item embedding for a prior content item associated with the user; and
selecting content items that are associated with respective content item embeddings that are within a threshold distance of the prior content item embedding.

5. The computer-implemented method of claim 1, wherein identifying the candidate content items includes:
obtaining user feature embeddings based on user features;
generating a user embedding based on the user feature embeddings using a first trained deep neural network (DNN);
selecting a first set of content items that includes content items that are associated with respective content item embeddings that are within a threshold distance of the user embedding;
obtaining a prior content item embedding for a prior content item associated with the user;
selecting a second set of content items that includes content items that are associated with respective content item embeddings that are within a threshold distance of the prior content item embedding; and
merging the first set of content items and the second set of content items.

6. The computer-implemented method of claim 1, wherein assigning the respective ranks is based on one or more of user interests of the user, content item inventory associated with the candidate content items, play history of the user, purchase history of the user, or recommendation context.

7. The computer-implemented method of claim 2, wherein the candidate content items are virtual experiences that include one or more developer items, and wherein the content item embedding for each virtual experience is a learned embedding based on respective developer item embeddings of the one or more developer items.

8. The computer-implemented method of claim 2, wherein the candidate content items are virtual experiences that include a plurality of assets that include one or more of audio assets, visual assets, or text assets, and wherein the content item embedding for each virtual experience is an asset embedding based on the plurality of assets associated with the virtual experience.

9. The computer-implemented method of claim 2, wherein the candidate content items are virtual experiences that include a plurality of assets and one or more developer items, and wherein the content item embedding for each virtual experience is a concatenation of an asset embedding based on the plurality of assets associated with the virtual experience and a learned embedding based on respective developer item embeddings of the one or more developer items.

10. The computer-implemented method of claim 2, wherein the candidate content items are one or more content items for purchase, and wherein the content item embedding for each content item for purchase is a respective item feature embedding of the one or more content items.

11. A non-transitory computer-readable medium with instructions stored thereon that, when executed by one or more hardware processors, cause the one or more hardware processors to perform operations, the operations comprising:
identifying candidate content items for recommendation to a user;
assigning respective ranks to the candidate content items, wherein the respective ranks are personalized to the user;
selecting, based on the respective ranks, one or more candidate content items from the candidate content items; and
providing the selected one or more candidate content items to a client device for display in a user interface.

12. The non-transitory computer-readable medium of claim 10, wherein identifying the candidate content items includes:
obtaining user feature embeddings based on user features;
generating a user embedding based on the user feature embeddings using a first trained deep neural network (DNN); and
selecting content items that are associated with respective content item embeddings that are within a threshold distance of the user embedding.

13. The non-transitory computer-readable medium of claim 11, wherein the first trained DNN is from a first tower of a two tower model that includes a second trained DNN from a second tower, and wherein the first trained DNN and the second trained DNN are trained to output user embeddings and content item embeddings that are close in vector space for user-content item pairs that have a groundtruth association and that are separated in vector space for user-content item pairs that do not have the groundtruth association.

14. The non-transitory computer-readable medium of claim 10, wherein identifying the candidate content items includes:
obtaining a prior content item embedding for a prior content item associated with the user; and
selecting content items that are associated with respective content item embeddings that are within a threshold distance of the prior content item embedding.

15. The non-transitory computer-readable medium of claim 10, wherein identifying the candidate content items includes:
obtaining user feature embeddings based on user features;
generating a user embedding based on the user feature embeddings using a first trained deep neural network (DNN);
selecting a first set of content items that includes content items that are associated with respective content item embeddings that are within a threshold distance of the user embedding;
obtaining a prior content item embedding for a prior content item associated with the user;
selecting a second set of content items that includes content items that are associated with respective content item embeddings that are within a threshold distance of the prior content item embedding; and
merging the first set of content items and the second set of content items.

16. The non-transitory computer-readable medium of claim 10, wherein assigning the respective ranks is based on one or more of user interests of the user, content item inventory associated with the candidate content items, play history of the user, purchase history of the user, or recommendation context.

17. The non-transitory computer-readable medium of claim 11, wherein the candidate content items are virtual experiences that include at least one of include a plurality of assets or one or more developer items, and wherein, when the candidate content items are virtual experiences that include the one or more developer items, the content item embedding for each virtual experience is a learned embedding based on respective developer item embeddings of the one or more developer items, or wherein, when the candidate content items are virtual experiences that include the plurality of assets and the one or more developer items, the content item embedding for each virtual experience is a concatenation of an asset embedding based on the plurality of assets associated with the virtual experience and a learned embedding based on respective developer item embeddings of the one or more developer items.

18. The non-transitory computer-readable medium of claim 11, wherein the candidate content items are virtual experiences that include a plurality of assets that include one or more of audio assets, visual assets, or text assets, and wherein the content item embedding for each virtual experience is an asset embedding based on the plurality of assets associated with the virtual experience.

19. The non-transitory computer-readable medium of claim 11, wherein the candidate content items are one or more content items for purchase, and wherein the content item embedding for each content item for purchase is a respective item feature embedding of the one or more content items.

20. A computing device, comprising:
one or more hardware processors; and
a non-transitory computer readable medium coupled to the one or more hardware processors, with instructions thereon, that when executed by the one or more hardware processors to perform operations, the operations comprising:
identifying candidate content items for recommendation to a user;
assigning respective ranks to the candidate content items, wherein the respective ranks are personalized to the user;
selecting, based on the respective ranks, one or more candidate content items from the candidate content items; and
providing the selected one or more candidate content items to a client device for display in a user interface.
